(19) United States
(12) Patent Application Publication
(10) Pub. No.: US 2018/0349825 A1
(43) Pub. Date: Dec. 6, 2018

(54) RIDESHARING MANAGING DEVICE, RIDESHARING MANAGING METHOD, AND STORAGE MEDIUM

(71) Applicant: HONDA MOTOR CO., LTD., Tokyo (JP)

(72) Inventors: Seiichi Yamamoto, Tokyo (JP); Naotoshi Fujimoto, Wako-shi (JP); Yo Ito, Tokyo (JP); Susumu Iwamoto, Tokyo (JP)

(21) Appl. No.: 15/979,581

(22) Filed: May 15, 2018

(30) Foreign Application Priority Data
May 30, 2017 (JP) 2017-106979

(51) Int. Cl. G06Q 10/06; G05D 1/00; G05D 1/02; G06Q 50/30

(52) U.S. Cl. CPC G06Q 10/06314; G06Q 50/30; G05D 1/0291; G05D 1/0088

(57) ABSTRACT

A ridesharing managing device (300) includes: an acquisition unit (320) configured to acquire a riding request in which riding conditions including a riding place and an alighting place of a user are defined; and a management unit (330) configured to search for allocable vehicles on the basis of the riding conditions of the riding request, to determine an operation schedule satisfying the riding conditions, and to determine the operation schedule satisfying the riding conditions by transferring from a first vehicle to a second vehicle among the allocable vehicles in a case that an operation schedule satisfying the riding conditions is not determined with one vehicle.

### CROSS-REFERENCE TO RELATED APPLICATION

Priority is claimed on Japanese Patent Application No. 2017-106979, filed May 30, 2017, the content of which is incorporated herein by reference.

### BACKGROUND OF THE INVENTION

### Field of the Invention

The present invention relates to a ridesharing managing device, a ridesharing managing method, and a storage medium.

### Description of Related Art

A ridesharing system that allocates a ride-shareable vehicle to a plurality of users having the same destination on the basis of users desiring ridesharing and current conditions of vehicles on which users ride together and supports the ridesharing has been proposed (for example, Japanese Unexamined Patent Application, First Publication No. 2009-289192).

### SUMMARY OF THE INVENTION

However, in the invention described in Japanese Unexamined Patent Application, First Publication No. 2009-289192, in a case that there is no allocable vehicle satisfying riding conditions such as a place, a time, and the like desired by a user, there is a problem in that a waiting time is caused for the user.

The invention is made in consideration of the above-mentioned circumstances and an objective thereof is to provide a ridesharing managing device, a ridesharing managing method, and a storage medium that can allocate a vehicle satisfying riding conditions desired by a user while reducing a waiting time even in a case that there is no vehicle satisfying the riding conditions desired by the user in ridesharing of a vehicle.

A ridesharing managing device, a ridesharing managing method, and a storage device according to the invention employ the following configurations.

(1) According to an aspect of the invention, there is provided a ridesharing managing device including: an acquisition unit configured to acquire a riding request in which riding conditions including a riding place and an alighting place of a user are defined; and a management unit configured to search for allocable vehicles on the basis of the riding conditions of the riding request, to determine an operation schedule satisfying the riding conditions, and to determine the operation schedule satisfying the riding conditions by transferring from a first vehicle to a second vehicle among the allocable vehicles in a case that an operation schedule satisfying the riding conditions is not determined with one vehicle.

(2) In the aspect of (1), the management unit may be configured to acquire routes of the allocable vehicles and to determine the operation schedule on the basis of the acquired routes in a case that the operation schedule is determined and may be configured to set a place at which a distance between a first route of the first vehicle and a second route of the second vehicle is the shortest or equal to or less than a predetermined distance as a transfer place in a case that the operation schedule in which the user transfers between the vehicles is determined.

(3) In the aspect of (2), the management unit may be configured to perform a process of changing the routes of the allocable vehicles to routes in which the transfer place is able to be set in a case that the transfer place is not able to be set.

(4) In the aspect of (3), the management unit may be configured to instruct an automatically driven vehicle so that a route of the automatically driven vehicle is changed in the process of changing the route in a case that the allocable vehicle is the automatically driven vehicle.

(5) In the aspect of (3), the management unit may be configured to instruct a navigation device so that a route for which guidance is performed by the navigation device of a manually driven vehicle is changed in the process of changing the route in a case that the allocable vehicle is the manually driven vehicle.

(6) In the aspect of (3), the process of changing the route may be a process of transmitting an inquiry and the management unit may be configured to instruct an onboard device of the vehicle or a terminal device of the occupant to change the route of the vehicle from which the inquiry has been transmitted and of which the occupant has agreed to the inquiry

(7) In the aspect of (6), the management unit may be configured to increase a usage fee for the user in a case that the route of the vehicle of which the occupant has agreed to the inquiry has been changed.

(8) According to another aspect of the invention, there is provided a ridesharing managing method causing a computer to perform: acquiring a riding request in which riding conditions including a riding place and an alighting place of a user are defined; and searching for allocable vehicles on the basis of the riding conditions of the riding request and determining an operation schedule satisfying the riding conditions by transferring from a first vehicle to a second vehicle among the allocable vehicles in a case that the operation schedule satisfying the riding conditions are not determined with one vehicle at the time of determination of the operation schedule satisfying the riding conditions.

(9) According to still another aspect of the invention, there is provided a non-transitory computer-readable storage medium recording a program causing a computer to perform: acquiring a riding request in which riding conditions including a riding place and an alighting place of a user are defined; and searching for allocable vehicles on the basis of the riding conditions of the riding request and determining an operation schedule satisfying the riding conditions by transferring from a first vehicle to a second vehicle among the allocable vehicles in a case that the operation schedule satisfying the riding conditions are not determined with one vehicle at the time of determination of the operation schedule satisfying the riding conditions.

According to the aspects of (1), (8), and (9), it is possible to determine an operation schedule of a vehicle to satisfy riding conditions of a user and to improve convenience.

According to the aspect of (2), a user can transfer efficiently in a case that the user transfers between a plurality of vehicles.

According to the aspects of (3) to (7), a user can transfer efficiently by changing a route of a vehicle even in a case that transfer from vehicle to vehicle could not be performed easily.

### BRIEF DESCRIPTION OF THE DRAWINGS

FIG. 1 is a diagram showing a configuration of a ridesharing system including a ridesharing managing device;

FIG. 2 is a diagram showing a configuration of a vehicle;

FIG. 3 is a diagram showing an automated driving processing process;

FIG. 4 is a diagram showing an example of contents of riding condition information;

FIG. 5 is a diagram showing an example in which a user transfers from vehicle to vehicle;

FIG. 6 is a diagram showing an example of contents of operation schedule information;

FIG. 7 is a diagram showing an example of a transfer place in an example in which a user moves on foot from an alighting place to a riding place;

FIG. 8 is a flowchart showing an example of a process routine which is performed by the ridesharing managing device;

FIG. 9 is a diagram showing an example in which a route of a vehicle is changed for transfer from vehicle to vehicle;

FIG. 10 is a diagram showing an example of an image which is displayed on a terminal device;

FIG. 11 is a diagram showing an example of an image in which a vehicle 200 inquires of an occupant about whether to change a route; and

FIG. 12 is a flowchart showing an example of a process routine which is performed by a ridesharing managing device according to another embodiment.

### DETAILED DESCRIPTION OF THE INVENTION

### First Embodiment

Hereinafter, a ridesharing managing device, a ridesharing managing method, and a storage medium according to an embodiment of the invention will be described with reference to the accompanying drawings. The ridesharing managing device is a device that supports common usage (ridesharing) of one or more vehicles by a plurality of users. A vehicle which is used for ridesharing is, for example, an automatically driven vehicle that does not basically require a driving operation. Hereinafter, although it is assumed that automatically driven vehicles are used for ridesharing, manually driven vehicles may be used.

In a case that a riding request is acquired from a terminal device of a user by communication, the ridesharing managing device searches for vehicles satisfying riding conditions (allocable vehicles) defined in the riding request. In a case that an operation schedule satisfying the riding conditions cannot be determined with one vehicle, the ridesharing managing device adjusts a vehicle allocation schedule so that the riding conditions are satisfied by transferring between a plurality of vehicles. The communication may include both data communication and voice communication, that is, phone communication.

[Entire Configuration]

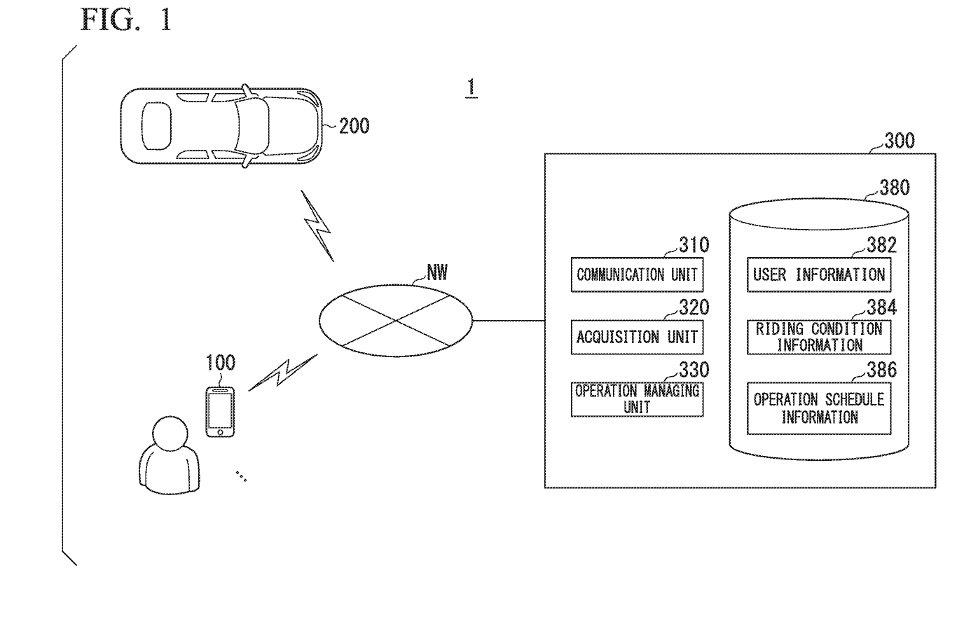

FIG. 1 is a diagram showing a configuration of a ridesharing system including a ridesharing managing device 300. The ridesharing system 1 includes one or more terminal devices 100 which are used by one or more users U, one or more vehicles 200, and the ridesharing managing device 300. These elements can communicate with each other via a network NW. The network NW may include the Internet, a wide area network (WAN), a local area network (LAN), public circuits, a provider device, a dedicated circuit, and a radio base station. “Being used by a user U” may include temporary usage of a terminal device such as a terminal device in a net café, which can be used by unspecified individuals, by the user U.

[Terminal Device]

A terminal device 100 is a mobile terminal such as a smartphone, a tablet terminal, or a personal computer. In the terminal device 100, an application program, a browser, or the like for using the ridesharing system is started to support a service which will be described below. The following description is based on the premise that the terminal device 100 is a smartphone and an application program (a ridesharing application) is started. The ridesharing application communicates with the ridesharing managing device 300 in response to an operation by the user U and transmits a request of the user U to the ridesharing managing device 300 or performs pushed notification based on information received from the ridesharing managing device 300.

[Vehicle]

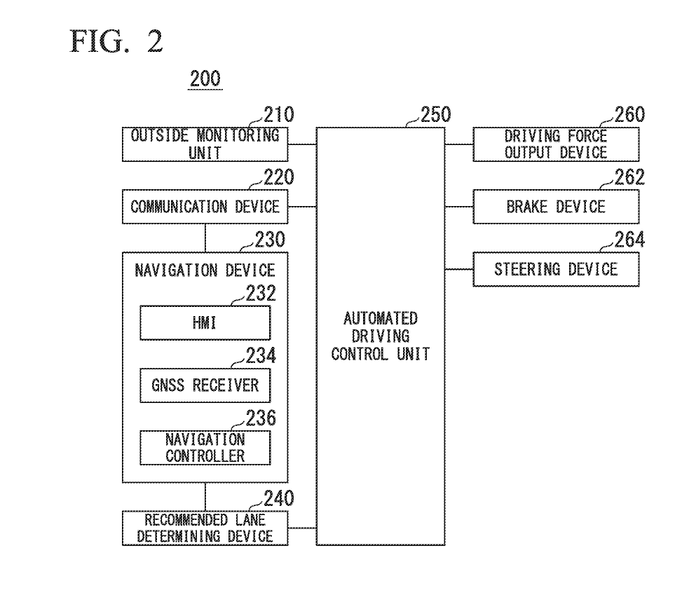

The vehicle 200 is a vehicle having four or more wheels on which a plurality of users U can ride, but may be a motorcycle or other vehicles. FIG. 2 is a diagram showing a configuration of the vehicle 200. The vehicle 200 includes, for example, an outside monitoring unit 210, a communication device 220, a navigation device 230, a recommended lane determining device 240, an automated driving control unit 250, a driving force output device 260, a brake device 262, and a steering device 264.

The outside monitoring unit 210 includes, for example, a camera or a radar, a light detection and ranging (LIDAR), and an object recognizing device that performs a sensor fusion process on the basis of outputs thereof. The outside monitoring unit 210 estimates a type of an object (particularly, a vehicle, a pedestrian, and a bicycle) which is present near the vehicle 200 and outputs the estimated type of an object to the automated driving control unit 250 along with information of a position or a speed of the object.

The communication device 220 is, for example, a radio communication module that accesses the network NW or communicates directly with another vehicle, a terminal device of a pedestrian, or the like. The communication device 220 performs radio communication on the basis of Wi-Fi, dedicated short range communications (DSRC), Bluetooth (registered trademark), or other communication standards. A plurality of communication devices may be prepared as the communication device 220 by applications.

The navigation device 230 includes, for example, a human-machine interface (HMI) 232, a global navigation satellite system (GNSS) receiver 234, and a navigation controller 236. The HMI 232 includes, for example, a touch panel type display device, a speaker, and a microphone. The GNSS receiver 234 measures a position of a host device (a position of the vehicle 200) on the basis of radio waves transmitted from GNSS satellites (for example, GPS satellites). The navigation controller 236 includes, for example, a central processing unit (CPU) and various storage devices and controls the navigation device 230 as a whole. Map information (a navigation map) is stored in the storage device.

The navigation map is a map in which a road is expressed in nodes and links. The navigation controller 236 determines a route from the position of the vehicle 200 measured by the GNSS receiver 234 to a destination designated using the HMI 232 with reference to the navigation map. The navigation controller 236 may transmit the position and the destination of the vehicle 200 to a navigation server (not illustrated) using the communication device 220 and acquire a route returned from the navigation server.

In this embodiment, information on a route to a destination may be designated or changed by the ridesharing managing device 300. The information on a route may include information of a transit place and a place and an arrival target time at which the vehicle stops to allow a user U to ride on or alight from a vehicle. The navigation controller 236 outputs the information on the route determined by one of the above-mentioned methods to the recommended lane determining device 240.

The recommended lane determining device 240 includes, for example, a map positioning unit (MPU) and various storage devices. Map information with higher accuracy than a navigation map is stored in the storage devices. The map information with high accuracy includes information such as a width and a gradient of each lane and positions of traffic signals. The recommended lane determining device 240 determines a recommended lane which is desirable for traveling along a route input from the navigation device 230, generates information of a route, a recommended lane, and a traveling time, and outputs the generated information to the automated driving control unit 250.

The automated driving control unit 250 includes one or more processors such as a CPU and a micro processing unit (MPU) and various storage devices. The automated driving control unit 250 causes the vehicle 200 to travel automatically so that contact with an object of which the position or the speed is input from the outside monitoring unit 210 is avoided under the principle that the vehicle travels on the recommended lane determined by the recommended lane determining device 240. The automated driving control unit 250 sequentially performs, for example, various events. Examples of the events include a constant-speed traveling event in which a vehicle travels on the same traveling lane at a constant speed, a following traveling event in which a vehicle follows a preceding vehicle, a lane change event, a merging event, a branching event, an emergency stop event, a tollgate event in which a vehicle passes through a tollgate, and a handover event in which automated driving is ended and switched to manual driving. In the course of performing such events, behavior for avoidance may be planned on the basis of surrounding conditions of the vehicle 200 (such as presence of a nearby vehicle or pedestrian and lane narrowing due to road construction).

The automated driving control unit 250 creates a target path on which the vehicle 200 will travel in the future. A target path includes, for example, a speed element. For example, a target path is expressed as a sequence of points (path points) at which the vehicle 200 will arrive. A path point is a point at which the vehicle 200 will arrive for each predetermined traveling distance, and a target speed and a target acceleration for each predetermined sampling time (for example, about a value in one decimal place [sec]) are generated as a part of a target path in addition to the path point. A path point may be a position at which the vehicle 200 will arrive at each sampling time for each predetermined sampling period of time. In this case, information of a target speed or a target acceleration is expressed by intervals between the path points.

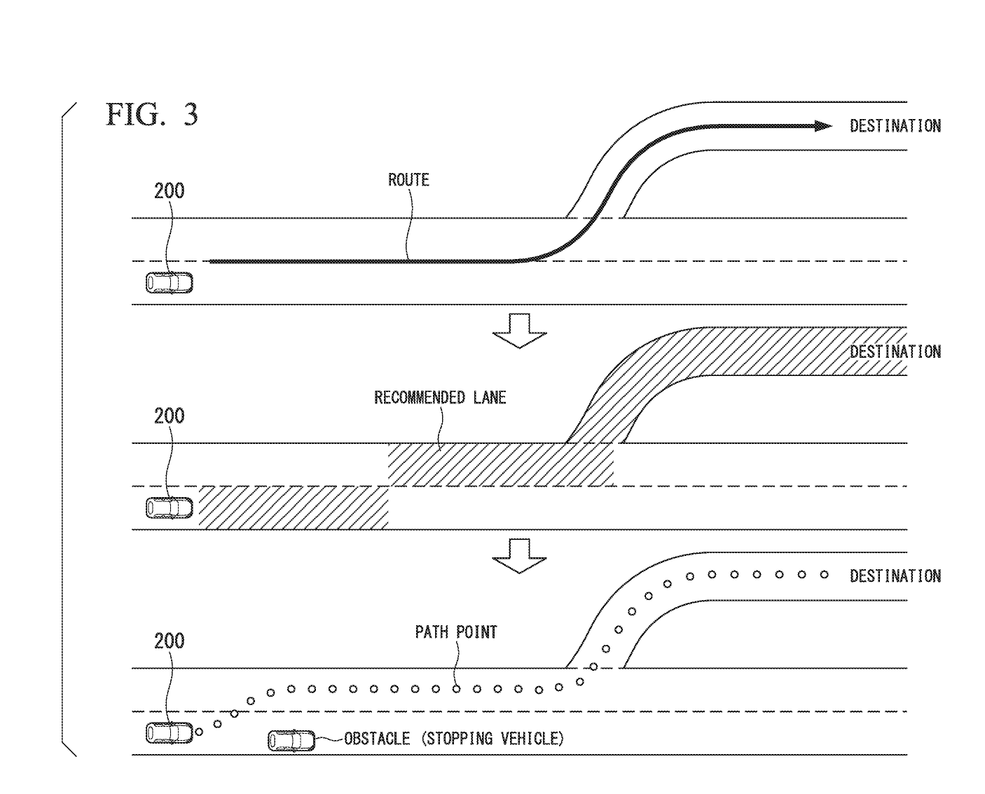

FIG. 3 is a diagram showing an automated driving process routine. First, as illustrated in the upper part of the drawing, a route is determined by the navigation device 230. This route is, for example, a rough route in which lanes are not distinguished. Then, as illustrated in the middle part of the drawing, the recommended lane determining device 240 determines a recommended lane on which the vehicle is likely to travel along the route. Then, as illustrated in the lower part of the drawing, the automated driving control unit 250 generates path points which are used for the vehicle to travel along the recommended lane as much as possible while avoiding an obstacle or the like, and controls some or all of the driving force output device 260, the brake device 262, and the steering device 264 so that the vehicle travels along the path points (and an additional speed profile). This distribution of functions is only an example and, for example, the automated driving control unit 250 may perform the functions in an integrated manner.

The driving force output device 260 outputs a travel driving force (a torque) for causing the vehicle 200 to travel to driving wheels. The driving force output device 260 includes, for example, a combination of an internal combustion engine, an electric motor, and a transmission and a power ECU that controls them. The power ECU controls the above-mentioned configuration on the basis of information input from the automated driving control unit 250 or information input from a driving operator which is not illustrated.

The brake device 262 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the automated driving control unit 250 or information input from the driving operator so that a braking torque based on a braking operation is output to vehicle wheels. The brake device 262 may include a mechanism for transmitting a hydraulic pressure generated by an operation of a brake pedal included in the driving operator to the cylinder via a master cylinder as a backup. The brake device 262 is not limited to the above-mentioned configuration, and may be an electronically controlled hydraulic brake device that controls an actuator on the basis of information input from the automated driving control unit 250 so that the hydraulic pressure of the master cylinder is transmitted to the cylinder.

The steering device 264 includes, for example, a steering ECU and an electric motor. The electric motor changes a direction of turning wheels, for example, by applying a force to a rack-and-pinion mechanism. The steering ECU drives the electric motor on the basis of information input from the automated driving control unit 250 or information input from the driving operator to change the direction of the turning wheels.

[Ridesharing Managing Device]

Referring back to FIG. 1, the ridesharing managing device 300 includes, for example, a communication unit 310, an acquisition unit 320, an operation managing unit 330, and a storage unit 380.

The communication unit 310 is, for example, a network card that is used for an access to the network NW. The storage unit 380 is embodied by a hard disk drive (HDD), a flash memory, a random access memory (RAM), a read only memory (ROM), or the like. The communication unit 310 communicates with the terminal device 100 or the vehicle 200 via the network NW.

The acquisition unit 320 and the operation managing unit 330 are embodied, for example, by causing a processor such as a CPU to execute a program (software) stored in the storage unit 380. Some or all of such functional units may be embodied by hardware such as a large scale integration (LSI), an application specific integrated circuit (ASIC), or a field-programmable gate array (FPGA) or may be embodied in cooperation of software and hardware. A combination of the communication unit 310 and the acquisition unit 320 is an example of an “acquisition unit.”

The acquisition unit 320 acquires a riding request which is issued from a terminal device 100 of a user U via the communication unit 310 and the network NW, and registers riding conditions included in the riding request in the storage unit 380 as riding condition information 384. User information 382 includes personal information of the user U or the like.

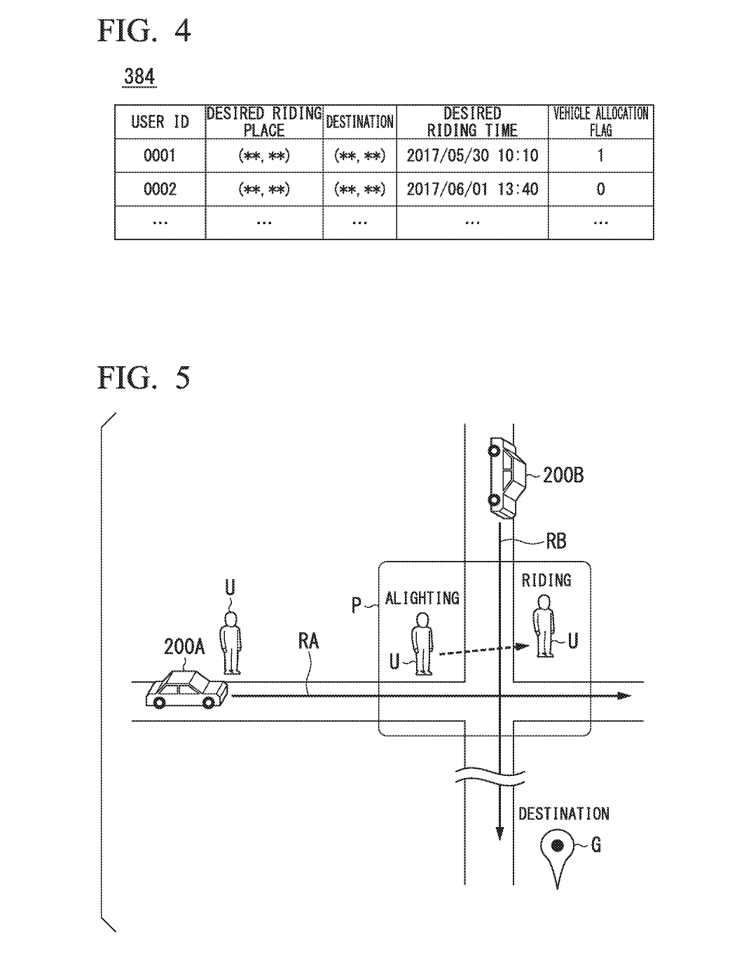

FIG. 4 is a diagram showing an example of contents of the riding condition information 384. As illustrated in the drawing, the riding condition information 384 is information in which a desired riding place, a destination, a desired riding time, and a vehicle allocation flag indicating whether allocation of the vehicle has been determined (for example, a value of 1 indicates that allocation of the vehicle has been determined and a value of 0 indicates that allocation of the vehicle has not been determined) are correlated with a user ID which is identification information of a user who has been previously registered. The riding condition information 384 may include a desired necessary time from a desired riding to arriving at a destination which can be allowed by the user or an arrival time at a destination which can be allowed by the user.

Details of information other than the vehicle allocation flag are determined by causing a ridesharing application of the terminal device 100 to receive an input from the user U, and are transmitted to the ridesharing managing device 300 as a riding request. In the following description, a sequence of information correlated with one user ID in the riding condition information 384 may be referred to as a record. Input information is transmitted to the ridesharing managing device 300 as a riding request.

The operation managing unit 330 searches for allocable vehicles 200 with reference to the riding condition information 384 and operation schedule information 386 on the basis of the received information. The operation managing unit 330 manages a usage fee for a user U having used ridesharing. The operation managing unit 330 searches routes of the vehicles 200 and extracts one or more vehicles 200 passing through a desired riding place and a destination of the user U. The operation managing unit 330 selects one vehicle 200 passing through the desired riding place at a time point closest to the desired riding time of the user U among the extracted one or more vehicles 200.

For example, the operation managing unit 330 roughly groups records in which time periods and traveling sections from the desired riding place to the destination are within predetermined ranges among the records included in the riding condition information 384, extracts one or more records associated with one or more users U who can transfer one or more vehicles 200, and registers the extracted one or more records in the storage unit 380 as a part of the operation schedule information 386.

Here, it cannot be said that an operation schedule satisfying riding conditions desired by a user U can be determined with one vehicle 200. For example, in a case that a route of a one allocable vehicle 200 does not include a desired riding place and a destination, a route satisfies the riding conditions but a necessary time is equal to or greater than a predetermined time due to the vehicle 200 traveling through a place other than the destination, or a route satisfies the riding conditions but a waiting time until the vehicle 200 arrives at the desired riding place is equal to or greater than a predetermined, the riding conditions desired by the user U are not satisfied.

However, the desired riding place of the user U, transit points, and the destination may be included in routes of a plurality of allocable vehicles 200, and the riding conditions desired by the user U may be satisfied by causing the user to transfer between a plurality of vehicles 200 in a case that transfer times match.

Therefore, in a case that an operation schedule satisfying the riding conditions of the user U cannot be determined with one vehicle 200, the operation managing unit 330 determines an operation schedule satisfying the riding conditions by causing the user to transfer between a plurality of vehicles 200 among the allocable vehicles 200. The operation managing unit 330 acquires, for example, information of routes of a plurality of vehicles 200 and extracts a plurality of vehicles 200 which can be used at the desired riding place by the user U to reach a destination. The plurality of vehicles 200 which can be used are, for example, a vehicle 200 on which the user rides from the desired riding place to a transfer place and a vehicle 200 on which the user rides from the transfer place to the destination. The plurality of vehicles 200 which can be used may include a vehicle 200 on which the user rides from one transfer place to a next transfer place in addition to the above-mentioned vehicles 200.

FIG. 5 is a diagram showing an example of a case in which a user transfers between vehicles 200. For example, regarding two vehicles 200 included in the plurality of extracted vehicles 200, the operation managing unit 330 determines an operation schedule in which the user transfers between the vehicles 200 on the basis of a route of a first vehicle 200A and a route of a second vehicle 200B.

Regarding two vehicles which the user will transfer, the operation managing unit 330 sets a place at which a distance between a first route RA of the first vehicle 200A and a second route RB of the second vehicle 200B is the shortest or equal to or less than a predetermined distance as a transfer place P. A transfer place P is a place at which the user U transfers between the vehicles 200. A place may be coordinates indicating one point or may be an area having a certain area. A period of time between a time at which the first vehicle 200A will arrive at the transfer place P and a time at which the second vehicle 200B will arrive at the transfer place P is, for example, within a predetermined time. This is because in a case that the period of time is equal to or greater than the predetermined time, a waiting time of the user U who rides the second vehicle 200B increases.

For example, in a case that routes of the first vehicle 200 and the second vehicle 200 intersect each other, the operation managing unit 330 sets a place at which both routes intersect each other as the transfer place P. For example, in a case that the routes of the first vehicle 200 and the second vehicle 200 do not intersect each other, the operation managing unit 330 sets a place at which the distance between the first route of the first vehicle 200 and the second route of the second vehicle 200 is the shortest or equal to or less than a predetermined distance as the transfer place P. In this case, the transfer place P is an area including a place in which the user alights from the first vehicle 200 and a place in which the user rides on the second vehicle 200.

The operation managing unit 330 repeatedly performs the above-mentioned process, sequentially generates an operation schedule of two vehicles 200 used for transfer, and determines an operation schedule satisfying the riding conditions of the user U by transferring between a plurality of vehicles 200.

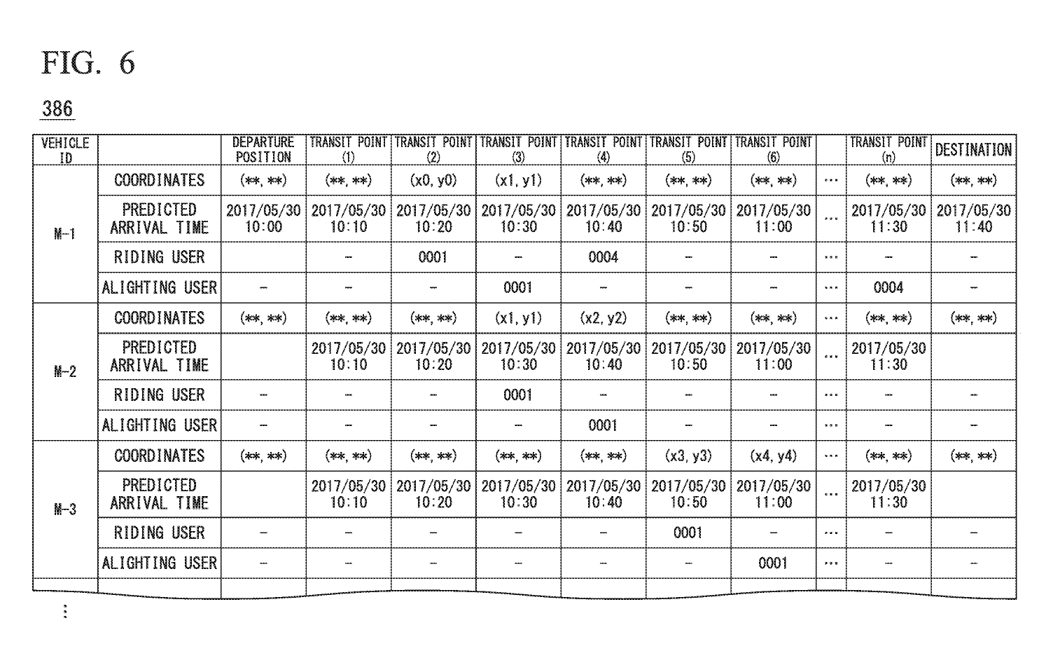

FIG. 6 is a diagram showing an example of contents of the operation schedule information 386. As illustrated in the drawing, the operation schedule information 386 is information in which coordinates of a departure position, transit points, and a destination, a predicted arrival time of the vehicle 200, and user IDs of users U riding at the transit points and users U alighting are correlated with vehicle IDs which are identification information of the vehicles 200 which are managed by the ridesharing managing device 300. The departure position or the destination is generally a garage.

In the example illustrated in FIG. 6, an operation schedule in which a route of a vehicle 200 (ID: M-1) and a route of a vehicle 200 (ID: M-2) intersect each other and the route of the vehicle 200 (ID: M-2) and a route of a vehicle 200 (ID: M-3) do not intersect each other is described. As illustrated in the drawing, for example, in a case that a user U (ID: 0001) moves from a desired riding place (a transit point (2) in the drawing) to a destination (a transit point (6) in the drawing), an operation schedule in which the user transfers between a plurality of vehicles 200 is determined. For example, the user U first moves from the desired riding place (the transit point (2) in the drawing) to a transfer place P (a transit point (3) in the drawing) by the vehicle 200 (ID: M-1). Since the route of the vehicle 200 (ID: M-1) and the route of the vehicle 200 (ID: M-2) between which the user transfers intersect each other, the user U waits for the vehicle 200 (ID: M-2) to which the user transfers at the transfer place P (the transit point (3) in the drawing) which is an alighting place.

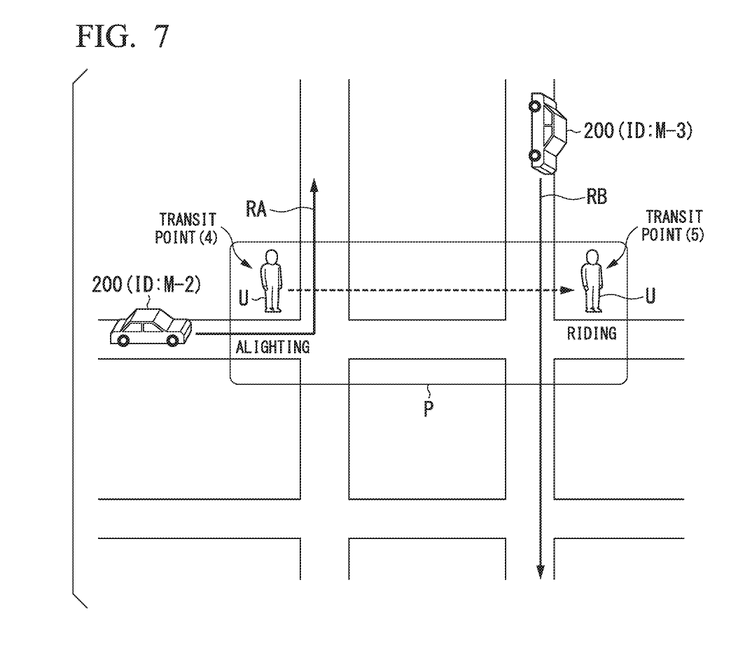

Then, for example, the user U rides the vehicle 200 (ID: M-2) and moves from the transfer place P (the transit point (4) in the drawing) to a transfer place P (a transit point (3) in the drawing). FIG. 7 is a diagram showing an example of a transfer place P in a case in which a user moves on foot from an alighting place to a riding place. As illustrated in the drawing, since the route of the vehicle 200 (ID: M-2) and the route of the vehicle 200 (ID: M-3) between which the user transfers do not intersect each other, the user U moves on foot from the transit point (4) in the drawing which is the alighting place to a riding place (a transit point (5) in the drawing) for the vehicle 200 (ID: M-3). In this case, the transfer place P is an area including the transit point (4) and the transit point (5). The “riding place” or the “alighting place” may not be information of a point (coordinates) and may be, for example, an area with a predetermined radius from a center point or an area in a map which is partitioned in a mesh shape.

Then, the user U rides on the vehicle 200 (ID: M-3) and moves from the transfer place P (the transit point (5) in the drawing) to the destination (a transit point (6) in the drawing). In this case, a period of time between a time point at which the vehicle 200 (ID: M-2) arrives at the transit point (4) in the drawing which is an alighting place and a time point at which the vehicle 200 (ID: M-3) arrives at the transit point (5) in the drawing which is a riding place is, for example, a predetermined time. In this example, the operation schedule is determined so that the vehicle 200 (ID: M-3) to which the user transfers arrives at the transfer place P later than the vehicle 200 (ID: M-2) from which the user U alights.

[Process Flow and Cases]

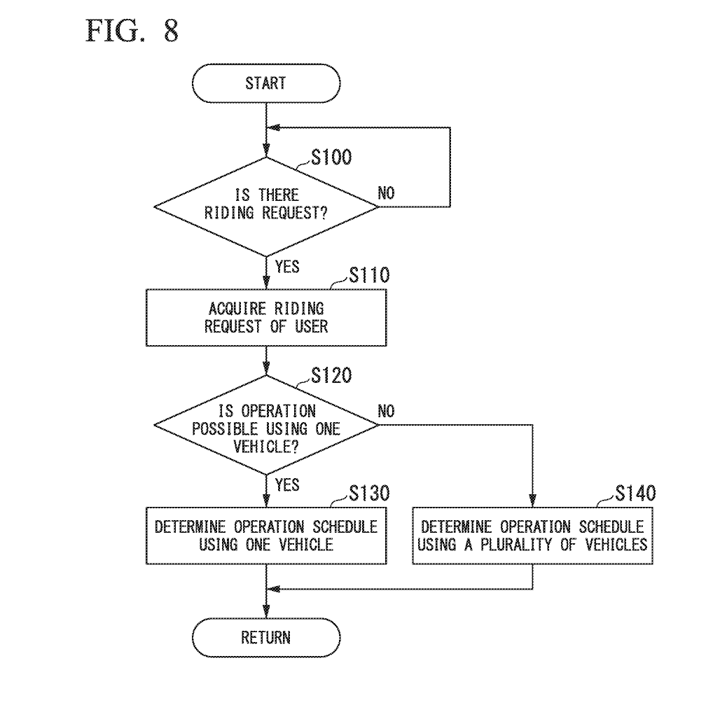

A process routine which is performed by the ridesharing managing device 300 will be described below. FIG. 8 is a flowchart showing an example of a process routine which is performed by the ridesharing managing device 300. The acquisition unit 320 determines whether a riding request in which riding conditions are defined has been issued from the terminal device 100 of the user U (Step S100). When the determination result of Step S100 is negative, the acquisition unit 320 repeatedly performs the process of Step S100. When the determination result of Step S100 is positive, the acquisition unit 320 acquires a riding request (Step S110).

The operation managing unit 330 determines whether an operation satisfying the riding conditions of the user U is possible with one vehicle 200 (Step S120). In Step S120, for example, in a case that a route of the one vehicle 200 includes a desired riding place and a destination of the user U and a desired riding time or a desired necessary time of the user U matches the operation time of the vehicle 200, the operation managing unit 330 determines that an operation satisfying the riding conditions of the user U is possible and determines the operation schedule using the one vehicle 200 (Step S130).

In Step S120, for example, in a case that the route of the one vehicle 200 does not include the desired riding place and the destination of the user U and the desired riding time or the desired necessary time of the user U does not match the operation time of the vehicle 200, the operation managing unit 330 determines that an operation satisfying the riding conditions of the user U is not possible using the one vehicle 200 and determines an operation schedule so that the user can arrive at the destination by transferring between a plurality of vehicles (Step S140).

In the above-mentioned ridesharing managing device 300 according to the first embodiment, even in a case that there is no one vehicle satisfying riding conditions desired by a user U in ridesharing, it is possible to determine an operation schedule satisfying riding conditions by transferring between a plurality of vehicles so that a riding request in which riding conditions of the user U are defined is satisfied.

### Second Embodiment

In the first embodiment, the ridesharing managing device 300 determines an operation schedule satisfying riding conditions desired by a user U without changing a route of a vehicle 200. On the other hand, in a second embodiment, the ridesharing managing device 300 changes a route of a vehicle 200 so that riding conditions desired by a user U are satisfied.

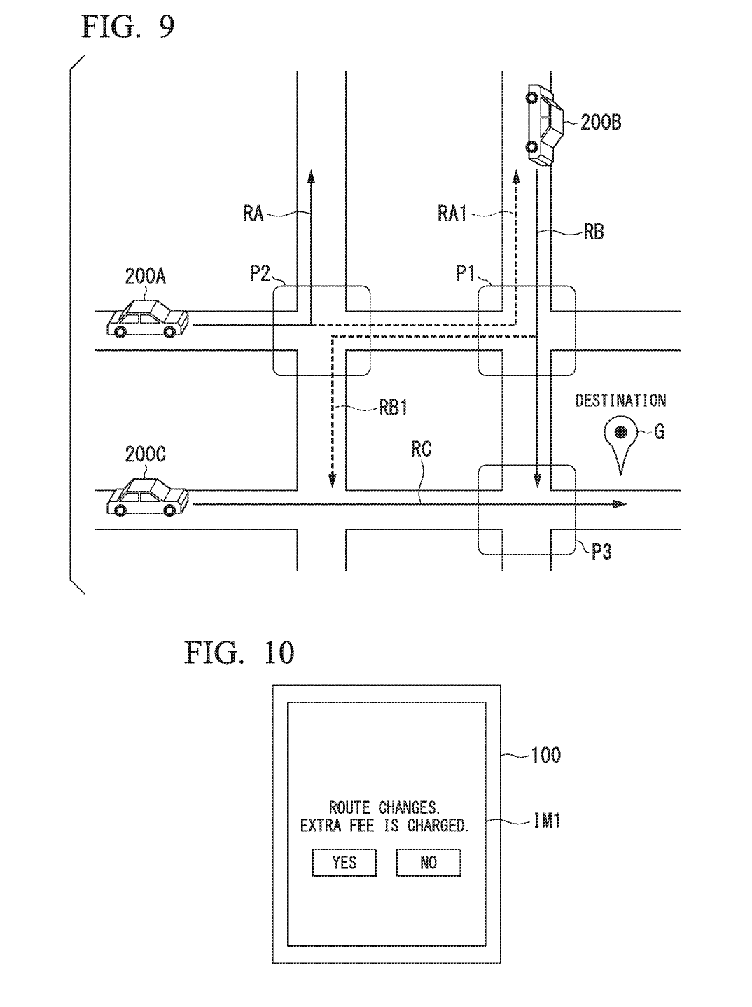

FIG. 9 is a diagram showing an example of a case in which a route of a vehicle 200 is changed for the purpose of transferring between vehicles 200. When a user U rides on a first vehicle 200A which is scheduled to travel on a route RA, the user needs to transfer to a third vehicle 200C of which a route includes a destination G in order to arrive at the destination.

When a first route RA of the first vehicle 200A and a third route RC of the third vehicle 200C do not intersect each other and the shortest distance between the routes is greater than a predetermined distance, the operation managing unit 330 cannot set a transfer place P.

On the other hand, a second route RB of a second vehicle 200B intersects the third route RC of the third vehicle 200C at a place (a transfer place P3) close to the destination G When the user U can ride on the second vehicle 200B, the user U can arrive at the destination G by transferring to the third vehicle 200C at the transfer place P3.

However, in a case that the first route RA of the first vehicle 200A and the second route RB of the second vehicle 200B do not intersect each other and the shortest distance between the routes is greater than a predetermined distance, the operation managing unit 330 cannot set a transfer place P.

Therefore, in a case that an operation schedule satisfying the riding conditions of the user U by transferring between a plurality of vehicles 200 cannot be determined, the operation managing unit 330 transmits an inquiry about whether to be able to change a route thereof to pass through a route in which a transfer place P can be set to a vehicle 200 searched for in the course of determination of a route.

When an inquiry is transmitted, a ridesharing application of the terminal device 100 of the user U transferring between a plurality of vehicles and moving to a destination may display an image IM1 for inquiring of the user U about whether to change the route of the vehicle 200 on a display unit of the terminal device 100 of the user U. FIG. 10 is a diagram showing an example of the image IM1 displayed on the terminal device 100. At this time, a message indicating that an extra fee is charged may be displayed in the image IM1 as will be described later.

The operation managing unit 330 extracts, for example, a plurality of transfer places P1 and P2 and sets a priority level in a case that the user transfers at the transfer place P1 close to the destination G to be higher than a priority level in a case that the user transfers at the transfer place P2. The operation managing unit 330 transmits an inquiry about whether to be able to change a route passing through the transfer place P1 to the first vehicle 200A.

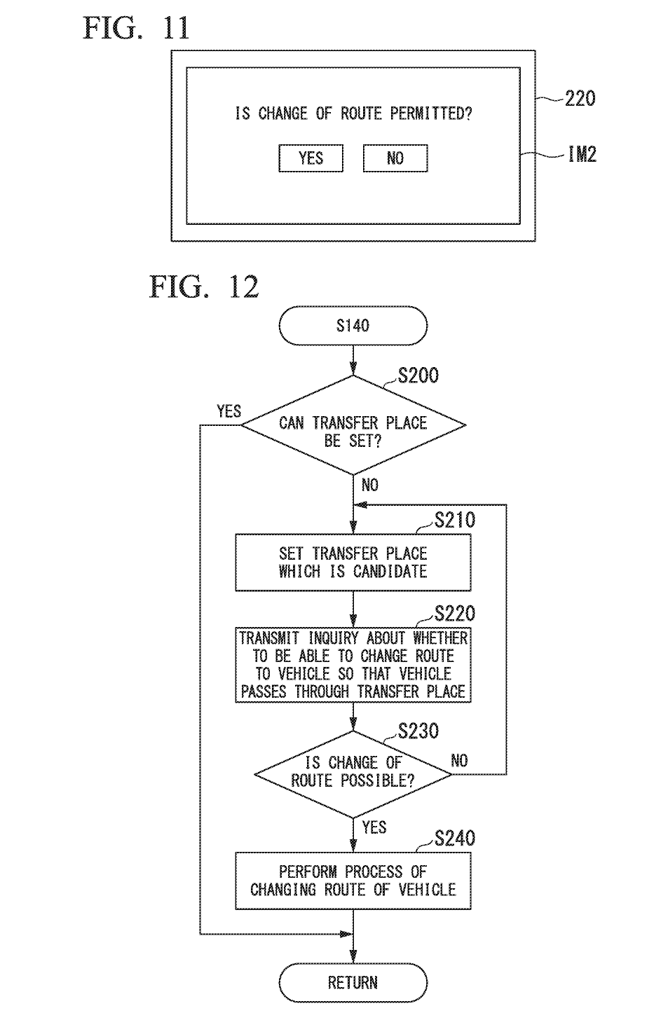

When the inquiry has been transmitted, an image IM for receiving whether a change of a route is permitted by an occupant of the vehicle 200 (whether it is permitted or not) may be displayed on the HMI 220 of the first vehicle 200A. FIG. 11 is a diagram showing an example of an image IM2 for receiving whether a change of a route is permitted by an occupant in a vehicle 200. When a representative or all of occupants of the first vehicle 200A has agreed to (permitted) the change of a route, the operation managing unit 330 performs a process of changing the route of the first vehicle 200A.

For example, in a case that the first vehicle 200A is an automatically driven vehicle, the operation managing unit 330 instructs the automatically driven vehicle to change a route of the automatically driven vehicle in the process of changing a route. In this case, the automatically driven vehicle changes a traveling route and a behavior plan on the basis of the instruction from the operation managing unit 330. For example, in a case that the first vehicle 200A is a manually driven vehicle, the operation managing unit 330 instructs a navigation device of the manually driven vehicle to automatically change a route for which guidance is performed by the navigation device in the process of changing a route. In this case, the navigation device displays a message indicating that the route has been changed for the user, changes the guidance route, and guides the user to the changed route. In addition, the operation managing unit 330 may display a message indicating that the route has been changed on a terminal device of a user (an occupant) of the manually driven vehicle.

The first vehicle 200A travels on a first route RA1 changed with the new route, and the user U transfers to the second vehicle 200B at the transfer place P1.

When the occupant of the first vehicle 200A has not agreed to the change of a route, the operation managing unit 330 instructs the second vehicle 200B to change the route thereof so that the user can transfer at the transfer place P2 with a second highest priority level.

In the second vehicle 200B, the recommended lane determining device 240 generates a new route on the basis of information instructed to the operation managing unit 330. The second vehicle 200B travels on a second route RB1 changed with the new route, and the user U transfers to the second vehicle 200B at the transfer place P2. When the occupant has agreed to the change of a route and the route of the second vehicle 200B has been changed, the operation managing unit 330 increases a usage fee for the user U who transfers to the second vehicle 200B. The operation managing unit 330 may discount a usage fee for the occupant who has agreed to the change of a route.

[Process Flow and Cases]

A process routine which is performed by the ridesharing managing device 300 will be described below. FIG. 12 is a flowchart showing an example of a process routine which is performed by a ridesharing managing device 300 according to a second embodiment. The following process routine is performed subsequent to Step S140 in the process flow according to the first embodiment.

The operation managing unit 330 determines whether a transfer place P can be set at the time of determining an operation schedule using a plurality of vehicles 200 (Step S200). When the determination result of Step S200 is positive, the operation managing unit 330 ends the process routine of the flowchart. When a transfer place P cannot be set in Step S200, the operation managing unit 330 sets a transfer place P as a candidate (Step S210). The operation managing unit 330 transmits an inquiry about whether a vehicle 200 selected to pass through the transfer place P as a candidate can change a route thereof to the vehicle 200 (Step S220).

Selection of the vehicle 200 is reasonably performed so that a distance by which the vehicle travels around to pass through the transfer place P as a candidate decreases. The operation managing unit 330 determines whether a change of a route is possible by inquiring of the vehicle 200 about whether to be able to change the route (Step S230). When the determination result of Step S230 is positive, the operation managing unit 330 instructs the vehicle 200 to change a route thereof (Step S240).

In a case that the determination result of Step S230 is negative, the operation managing unit 330 sets another transfer place P as a next candidate (Step S210). For example, in a case that a candidate of a transfer place P has been set a predetermined number of times but a transfer place cannot be set, the operation managing unit 330 notifies the user U of the intent or notifies the user U of information indicating an alternative means to the destination. Examples of the alternative means include allocation of a vehicle 200 in which a necessary time is equal to or greater than a predetermined time and allocation of a vehicle 200 in which a waiting time until arriving at a desired riding place is equal to or greater than a predetermined time.

In the above-mentioned ridesharing managing device 300 according to the second embodiment, a user U can transfer between a plurality of vehicles 200 and arrive at a destination by changing a route of a vehicle 200 even in a case that a transfer place P cannot be set.

While embodiments of the invention have been described above, the invention is not limited to the embodiments. The invention can be subjected to various modifications and substitutions without departing from the gist of the invention.

For example, the ridesharing managing device 300 may be mounted in a vehicle 200.

In a case that a vehicle 200 is a manually driven vehicle, the communication unit 310 may communicate with a terminal device of a driver of the vehicle 200 via the network NW.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A ridesharing managing device comprising:
an acquisition unit configured to acquire a riding request in which riding conditions including a riding place and an alighting place of a user are defined; and
a management unit configured to search for allocable vehicles on the basis of the riding conditions of the riding request, to determine an operation schedule satisfying the riding conditions, and to determine the operation schedule satisfying the riding conditions by transferring from a first vehicle to a second vehicle among the allocable vehicles in a case that an operation schedule satisfying the riding conditions is not determined with one vehicle.

2. The ridesharing managing device according to claim 1, wherein the management unit is configured to acquire routes of the allocable vehicles and to determine the operation schedule on the basis of the acquired routes in a case that the operation schedule is determined and is configured to set a place at which a distance between a first route of the first vehicle and a second route of the second vehicle is the shortest or equal to or less than a predetermined distance as a transfer place in a case that the operation schedule in which the user transfers between the vehicles is determined.

3. The ridesharing managing device according to claim 2, wherein the management unit is configured to perform a process of changing the routes of the allocable vehicles to routes in which the transfer place is able to be set in a case that the transfer place is not able to be set.

4. The ridesharing managing device according to claim 3, wherein the management unit is configured to instruct an automatically driven vehicle so that a route of the automatically driven vehicle is changed in the process of changing the route in a case that the allocable vehicle is the automatically driven vehicle.

5. The ridesharing managing device according to claim 3, wherein the management unit is configured to instruct a navigation device so that a route for which guidance is performed by the navigation device of a manually driven vehicle is changed in the process of changing the route in a case that the allocable vehicle is the manually driven vehicle.

6. The ridesharing managing device according to claim 4, wherein the management unit is configured to checked whether an occupant of a vehicle to which the instruction has been transmitted has agreed to the instruction and to instruct an onboard device of the vehicle or a terminal device of the occupant to change the route of the vehicle in a case that the occupant of the vehicle has accepted the instruction.

7. The ridesharing managing device according to claim 6, wherein the management unit is configured to increase charging for the user in a case that the route of the vehicle is changed by acceptance of the occupant of the vehicle.

8. A ridesharing managing method using a computer, comprising:
acquiring a riding request in which riding conditions including a riding place and an alighting place of a user are defined; and
searching for allocable vehicles on the basis of the riding conditions of the riding request and determining an operation schedule satisfying the riding conditions by transferring from a first vehicle to a second vehicle among the allocable vehicles in a case that an operation schedule satisfying the riding conditions is not determined with one vehicle at the time of determination of the operation schedule satisfying the riding conditions.

9. A non-transitory computer-readable storage medium recording a program causing a computer to perform:
acquiring a riding request in which riding conditions including a riding place and an alighting place of a user are defined; and
searching for allocable vehicles on the basis of the riding conditions of the riding request and determining an operation schedule satisfying the riding conditions by transferring from a first vehicle to a second vehicle among the allocable vehicles in a case that an operation schedule satisfying the riding conditions is not determined with one vehicle at the time of determination of the operation schedule satisfying the riding conditions.
